(19) United States
(12) Patent Application Publication
(10) Pub. No.: US 2005/0049919 A1
(43) Pub. Date: Mar. 3, 2005

(54) Method for advertising

(76) Inventor: John W. Disterdick, Hixson, TN (US)

Correspondence Address: J. Andrew Huffman, #227, 5251 C Highway 153, Hixson, TN, 37343, US

(21) Appl. No.: 10/926,132

(22) Filed: Aug. 25, 2004

Related U.S. Application Data
(60) Provisional application No. 60/497,659, filed on Aug. 25, 2003.
(60) Provisional application No. 60/498,099, filed on Aug. 27, 2003.

(51) Int. Cl. G06F 17/60

(52) U.S. Cl. 705/14

(57) ABSTRACT

A method of advertising in which primary advertisers and secondary advertisers cooperatively provide advertising directed toward a target market of consumers. The advertisers may cooperatively produce advertising products embodied in communications media, which can incorporate certain consumer benefits in addition to advertising material from primary and secondary advertisers. The advertisers may share certain costs associated with the advertising products. The final advertising product can be used to convey the advertising material of all participating advertisers to their target market.

This application claims the benefit of, and incorporates by reference, U.S. Provisional Application No. 60/497,659, filed Aug. 25, 2003, and U.S. Provisional Application No. 60/498,099, filed Aug. 27, 2003.

### BACKGROUND OF THE INVENTION

The invention relates generally to the field of advertising, and more particularly to a method enabling multiple advertisers to apply efforts or resources jointly for their collective benefit. In the field of advertising, it is desirable for the provider of advertising services to obtain as many clients as possible at the highest fee possible. On the other hand, it is desirable for clients to obtain advertising fees at the lowest fee possible. In addition, it is also desirable to distribute advertising to targeted markets to increase the possibility of generating the most sales for the lowest cost of advertising as possible. Thus, there are competing financial interests between providers of advertising services and clients for these services. One way to minimize these conflicts is to have several clients participate in a single advertising work product, but, at present, there is no method known for providing such a single advertising work product to a multiplicity of clients that is as potentially attractive to the provider of advertising services and to each of the clients as the method described herein.

### BRIEF SUMMARY OF THE INVENTION

The present invention addresses these problems and provides a single advertising product to a primary client and to one or more participating secondary clients. By this method, the provider can charge a relatively large fee for the advertising product, a portion of which may be paid by the primary client and the balance of which is paid by the secondary clients. The fee paid by the primary client can, thus, be competitive compared to fees charged by competing advertising providers not using this method, and, likewise, the fees paid by the secondary clients would also be competitive. In addition, the participating secondary clients benefit from exposure to the targeted market of the primary client. For example, in a case where the primary client is a reputable not-for-profit organization having extensive contacts with members, donors, volunteers, participants, etc., the secondary clients or other primary clients may otherwise have considerable difficulty gaining access to such contacts.

Other aspects of the invention will appear hereafter. The invention may be more fully understood upon consideration of the following description and with reference to the accompanying drawings.

### DRAWINGS REFLECTING A PREFERRED EMBODIMENT

FIG. 1 is a chart illustrating cooperation among several entities in the production and financing of an advertising project.

FIG. 2 is a chart further illustrating cooperation among several entities in the production and financing of an advertising project.

FIG. 3 is a chart illustrating cooperation among several entities in the production and financing of an advertising project which, in part, involves special programming.

FIG. 4 is a chart illustrating expansion from an initial focal advertising project to other advertising projects.

### DESCRIPTION OF THE INVENTION

The term “advertising” is used in its broadest sense—e.g., presentation or promotion of any good, service, relationship, entity, idea, or image, or communication of any message (whether or not for financial profit). The term can also be construed simply as “creating awareness.” “Client” or “advertiser” interchangeably refer to any entity with an interest in advertising. “Primary” and “secondary” describe relative significance according to some measure, and not necessarily chronological sequence. Primary and secondary advertisers in some cases may not be clearly distinct from one another. A “provider” means an entity with an interest in facilitating advertising. A provider may also happen to be an advertiser, or vice versa. A “targeted market” or “target market” means a segment of the population or other broader marketplace in which an advertiser or provider has some special interest. “Fee” or “cost” interchangeably signify, in the most general sense, resources involved in achieving desired advertising. “Benefit” broadly includes any value, advantage, gain, improvement, advance, or aid potentially available to or accruing to an entity (whether or not then perceived). “Consumer” means a member of a targeted market. “Media” means any means of communication, distribution, or advertising, including without limitation electronic, telephonic, video, television, internet, satellite, audio, mail, CDs, DVDs, and the like, and any type of distribution or communication system presently unknown which becomes available in the future.

The invention provides unique opportunities for allocating the costs and benefits of advertising among a group of advertisers. A provider may also be involved in the arrangement, and it is typically expected that consumers will be involved, at least as targets of advertising and potentially in other beneficial ways as well.

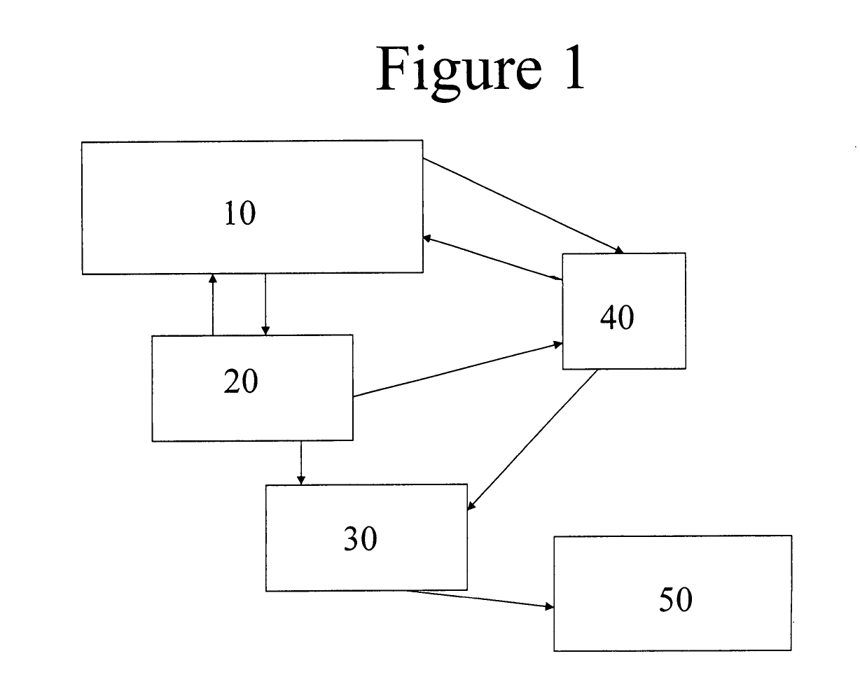

One implementation of the method of the present invention is illustrated in FIG. 1. An advertising provider 10 may solicit a primary client 20 to create for the primary client 20 an advertising product 30 that targets a market specific to the primary client 20's interests. The advertising provider 10 and/or the primary client 20 can solicit secondary participating clients 40 which would benefit by advertising to the targeted market of the primary client 20 with the advertising product 30. The total fee for the advertising product 30, which may be payable to or through the advertising provider 10, can be shared by the primary and secondary clients 20, 40 so that the fees paid by each client are relatively low. In this manner, the advertising provider 10 might increase total sales of advertising services as a result of relatively low per-client fees. The final advertising product 50 can be distributed to the target market by any type of media. The arrows in FIG. 1 illustrate some of the many possible paths of costs, benefits, relationships, production, and distribution in the arrangement described.

Accordingly, the present invention can comprise a method for marketing advertising services for targeted markets, potentially involving one or more steps of identifying a primary client, providing an advertising product for said primary client for distribution to one or more targeted markets, identifying one or more secondary clients, including advertising of each said secondary client with said advertising product of said primary client, and distributing costs for said advertising product among said primary client and said secondary clients.

It is further possible that the fees paid by the secondary clients can largely or completely offset the fee for the primary client, thus eliminating or substantially reducing the cost to the primary client, or even providing an initial net profit to the primary client. Further, when a portion of the fees paid by the secondary clients optionally is paid to or otherwise accrues to the benefit of the primary client, the primary client may have additional incentives to use the present method and to solicit additional secondary clients. Accordingly, the present invention may further comprise a method for marketing advertising services for targeted markets, potentially involving one or more of the steps mentioned in the preceding paragraph, as well as one or more of the steps of said secondary clients paying for said advertising product, and said primary client receiving a portion of the payment from said secondary clients.

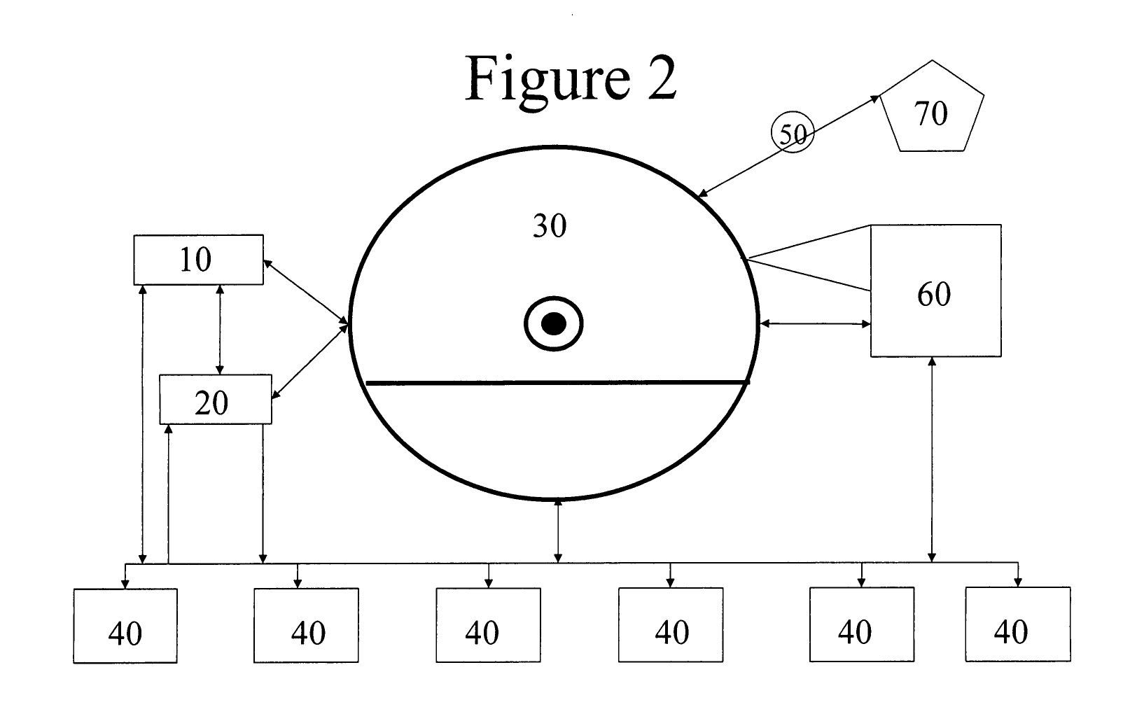

An embodiment of the method of the present invention is further illustrated in FIG. 2. If an advertising provider 10 is involved, it may enter into advertising arrangements with a primary advertiser 20 to create an advertising product 30 that targets a market 70 related to the primary advertiser 20's interests. In this FIG. 2, the advertising product 30 is conceptually represented by the shape of a data-carrying disk (such as a CD, DVD, etc.), although many other forms of media could be used. Advertising relationships can be established with secondary advertisers 40 which have some interest in advertising to the targeted market 70. The advertising of each of these advertisers 20, 40 can be combined in the advertising product 30 before it is disseminated within the targeted market 70 as final advertising product 50.

To enhance its effectiveness, the advertising product 30 and final advertising product 50 may incorporate certain benefits 60 with its advertising content. These benefits 60 may include any of a wide variety of possible consumer incentive elements, such as, illustratively: coupons, tickets, raffle tickets, premiums, membership opportunities, incentives to share the media with other consumers, prize opportunities, discounts, buying club opportunities, affiliate credit card offers, value-added content, free offers, trial offers, sweepstakes, networking incentives, special information, hotlinks, special services, software, or other offers, opportunities, promotions, services, or products. Such benefits 60 typically, though not always, would have some connection to one or more participants in the advertising arrangement such as provider 10 or advertisers 20, 40. For example, if primary advertiser 20 is a national not-for-profit organization, benefits 60 could include a discounted membership in the organization; or if one of the secondary advertisers 40 is a retail establishment, benefits 60 could include a discount coupon for use in the establishment and an Internet link to selected web pages of the establishment.

As will be clear to persons of skill in the art of marketing, well-designed benefits 60 flowing to consumers typically will also produce benefits within the group of advertisers 20, 40. Some of these potential advertiser benefits include, without limitation, increased sales, leads, visibility, image enhancement, subscriptions, contracts, establishment of memberships or other relationships, donations, creation of ongoing revenue streams, marketing efficiencies, consumer data tracking, access to unique audiences or unique distribution channels, positive affiliation with other advertisers, reduced-cost distribution of information, etc.

Costs associated with the advertising product 30 and distribution of the final advertising product 50 can be shared by the primary and secondary advertisers 20, 40 so that the costs borne by each advertiser are relatively low compared to the cost of producing a similar advertising product alone. The advantages to advertisers 20, 40 of reduced cost and potentially enhanced benefits are clear. In addition, if an advertising provider 10 is involved, its total sales of advertising services could increase as a result of relatively low per-advertiser fees, and provider 10 also could potentially generate new revenue streams through the distribution of final advertising product 50 (e.g., by charging a sale price or distribution fee, sharing in a portion of advertising revenues and collateral revenues generated, etc.). The final advertising product 50 can be distributed to the target market 70 by any type of media. The arrows in FIG. 2 illustrate some of the many possible paths of costs, benefits, relationships, production, and distribution in the arrangement described.

By way of example and illustration only, the provider 10 could be an entity such as an advertising agency or a production company; the primary client 20 could be a significant commercial advertiser or not-for-profit organization. The secondary clients 40 could be other commercial advertisers or not-for-profit organizations whose advertising interests overlap to some degree with the advertising interests of primary client 20 or with target market 70.

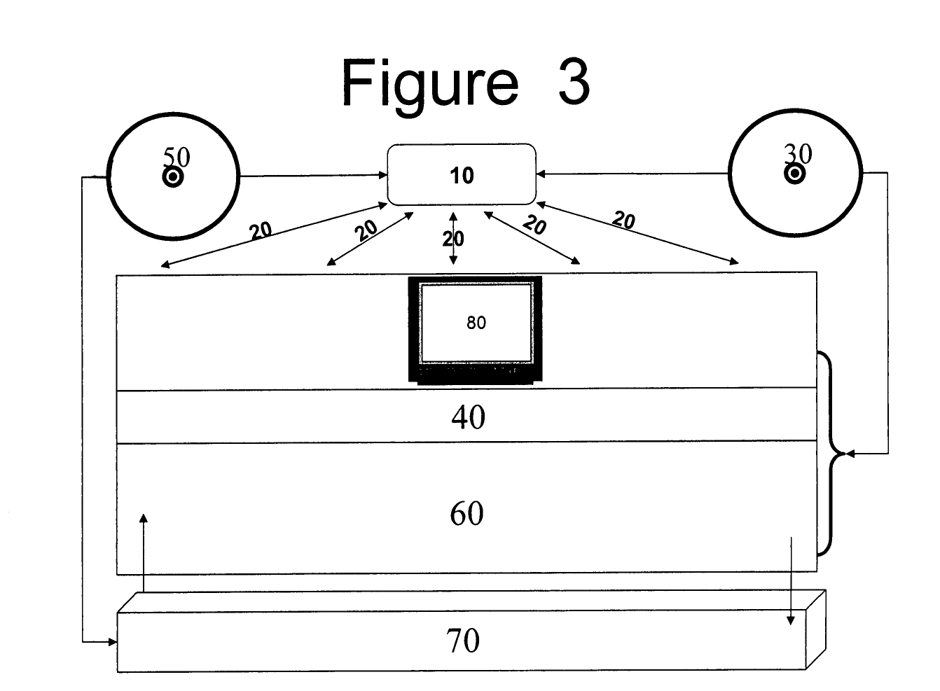

An embodiment of the method of the present invention is further illustrated in FIG. 3. In the particular embodiment here illustrated, the method of cooperation among several entities in the production and financing of an advertising project additionally involves special programming 80. Illustratively, programming 80 could be a specialized television program or similar production; many other kinds of programming could be used as well. Programming 80 is simply a special case of advertising product 30 and final advertising product 50, representing another opportunity for dissemination of advertising to target market 70.

Possibly with the involvement of provider 10, primary advertisers 20 support creation of programming 80 that targets a market 70 related to the interests of primary advertisers 20. Advertising relationships can be established with several primary advertisers 20, as well as with secondary advertisers 40 which have some interest in advertising to the targeted market 70. Advertisers 20, 40 may be given opportunities to contribute advertising content to programming 80, additional advertising product 30, or both. Advertising by some of these advertisers 20, 40 may or may not be directly included in the programming 80 (e.g., via commercial messages, product placements, endorsements, acknowledgments, etc.), but may be included in the additional advertising product 30 before it is disseminated within the targeted market 70 as final advertising product 50. As above, benefits 60 may be provided to target market 70 in connection with programming 80, final advertising product 50, or both, generating resultant benefits for advertisers 20, 40.

Programming 80 and final advertising product 50 may exhibit a symbiotic relationship—e.g., portions of the content of programming 80 may be included in final advertising product 50 to achieve an additional path of distribution to target market 70; also, final advertising product 50 may be promoted as part of programming 80. Benefits and cost distribution can be realized in the same manner as described above, with the additional potential benefit provided by the mutual leveraging of advertising influence between programming 80 and final advertising product 50. The arrows in FIG. 3 illustrate some of the many possible paths of costs, benefits, relationships, production, and distribution in the arrangement described.

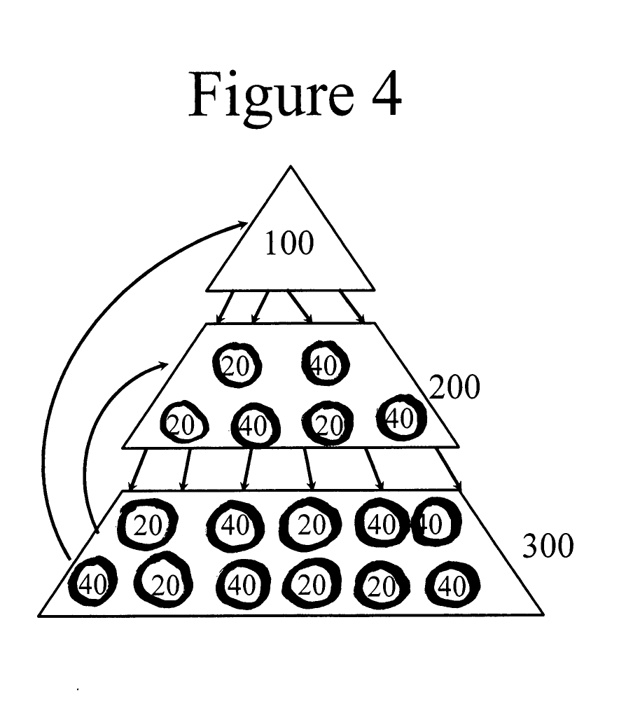

An embodiment of the method of the present invention is further illustrated in FIG. 4, which depicts expansion from an initial focal advertising project 100 to other advertising relationships and projects. Here, initial project 100 represents a cooperative advertising effort (e.g., an advertising effort such as the examples previously described) that is perceived as successful. The success of project 100 then can be leveraged into creating new advertising relationships or expanding existing advertising relationships. At tier 200, such relationships are forged with one or more potential primary advertisers 20 and secondary advertisers 40 that have an interest in broad, continuing, cooperative advertising efforts. By way of example, the tier 200 advertisers could be advertisers with interest in several markets nationwide. Relationships at tier 200 having been thus established or expanded, additional relationships can be established or expanded at tier 300 with potential primary advertisers and secondary advertisers for case-by-case advertising projects. For example, tier 300 relationships could be directed primarily at local or regional advertising efforts. Assembling an appropriate combination of tier 200 advertising relationships and tier 300 advertising relationships, coupled with continuing efforts to expand and establish relationships at both levels, could provide a foundation for an attractive ongoing advertising business model.

Illustrating such a business expansion, tier 200 relationships could, for example, be established with a major personal computer retailer, an international beverage company, a national Internet service provider, and a widely respected not-for-profit organization. The companies in these tier 200 relationships could be secondary advertisers 40 or primary advertisers 20, each of them with an interest in advertising to a number of different markets and/or advertising over an extended period of time. A package of one or more such tier 200 relationships then could be marketed to other advertisers with a view toward creating tier 300 relationships. For example, tier 300 relationships could be established with a local not-for-profit organization chapter, a university, a religious institution, and an electronics store. Then advertising projects could be tailored to the advertising needs of each tier 300 advertiser, financed in part by a group of the tier 200 advertisers that are interested in advertising to the same market(s) as one or more of the tier 300 advertisers. For example, the university could become a primary advertiser 20 supplying advertising content desired by students, applicants, parents, alumni, or other communities of interest—e.g., a course catalog, school year calendar, schedule of athletic and extracurricular events, and student/faculty directory. Other tier 300 advertisers with partly overlapping target markets might join the university's project as secondary advertisers 40. A package of one or more tier 200 advertisers could join the university's project as additional secondary advertisers 40. The resulting final advertising product (e.g., a DVD, CD, etc.) typically would primarily carry the university's advertising and labeling (as primary advertiser), together with advertising content and consumer benefits relating to the group of secondary advertisers. In this way, companies such as the large computer retailer and the national Internet service provider could gain otherwise difficult direct (even interactive, in some cases) advertising access to a highly focused target market such as the university's student body. Favorable results in this advertising effort could amount to another successful advertising project 100, continuing a constructive cycle of creating, building, and expanding advertising relationships.

Many variations may be made to the foregoing description and accompanying drawings without departing from the scope of the invention, and so it is intended that the matter contained in the description and drawings be construed in an illustrative and not in a limiting sense.

1. A method of advertising comprising:
identifying one or more primary advertisers;
identifying one or more target markets associated with said primary advertisers;
identifying one or more secondary advertisers having an interest in advertising to one or more of said target markets;
producing at a cost one or more advertising products embodied in communications media, said advertising products incorporating (a) advertising material from said primary advertisers, (b) advertising material from said secondary advertisers, and (c) one or more consumer benefits; at least some of said secondary advertisers making one or more payments in relation to said advertising products;
distributing said advertising products to said target markets.

2. A method according to claim 1, wherein said communications media comprise computer-readable data storage devices.

3. A method according to claim 2, wherein at least one of said primary advertisers is a not-for-profit organization.

4. A method according to claim 3, further comprising collecting said payments from at least some of said secondary advertisers, in an amount sufficient to at least offset said cost of said advertising products.

5. A method according to claim 1, further comprising using said advertising products to create one or more continuing streams of revenue from consumers.

6. A method according to claim 5, wherein at least some of said primary advertisers receive a benefit from said streams of revenue.

7. A method according to claim 1, wherein at least one of said primary advertisers is a not-for-profit organization.

8. A method according to claim 7, wherein said advertising products are embodied in communications media readable by equipment selected from the group consisting of computer, magnetic, electrical, electronic, and wireless equipment.

9. A method according to claim 7, further comprising using said advertising products to create one or more continuing streams of revenue from consumers, and wherein said not-for-profit organization receives a benefit from said streams of revenue.

10. A method of advertising comprising:
identifying one or more primary advertisers;
identifying a general target market with respect to said primary advertisers;
producing consumer-oriented programming content;
identifying one or more secondary advertisers having an interest in advertising to at least a portion of said general target market;
incorporating with said programming content advertising material from at least one of said primary advertisers or said secondary advertisers;
producing one or more advertising products embodied in communications media, said advertising products incorporating (a) advertising material from said primary advertisers, (b) advertising material from said secondary advertisers, (c) one or more consumer benefits, and (d) at least a portion of said programming content;
incorporating into said programming content a solicitation for expressions of interest in said advertising products;
communicating said programming content toward said general target market;
receiving expressions of interest in said advertising products, at least partly in response to said solicitation, and identifying a specific target market therefrom;
distributing said advertising products to said specific target market.

11. A method according to claim 10, wherein said communicating comprises transmitting said programming content in a television signal.

12. A method according to claim 11, wherein said communications media comprise computer-readable data storage devices.

13. A method according to claim 12, wherein at least one of said primary advertisers is a not-for-profit organization.

14. A method according to claim 12, further comprising using said advertising products to create one or more continuing streams of revenue from consumers.

15. A method of promoting advertising opportunities comprising:
identifying one or more first-tier advertisers;
establishing an advertising relationship with said first-tier advertisers;
identifying one or more second-tier advertisers;
identifying a desirable target market associated with at least one of said first-tier advertisers or said second-tier advertisers;
promoting to said second-tier advertisers a joint advertising opportunity with said first-tier advertisers;
producing one or more advertising products embodied in communications media, said advertising products incorporating (a) advertising material from said first-tier advertisers, (b) advertising material from said second-tier advertisers, and (c) one or more consumer benefits;
distributing said advertising products to said target market.

16. A method according to claim 15, wherein said communications media comprise computer-readable data storage devices.

17. A method according to claim 16, wherein at least one of said first-tier advertisers is a not-for-profit organization.

18. A method according to claim 16, wherein at least one of said second-tier advertisers is a not-for-profit organization.

19. A method according to claim 15, wherein said advertising products are embodied in communications media readable by equipment selected from the group consisting of computer, magnetic, electrical, electronic, and wireless equipment.

20. A method according to claim 19, further comprising using said advertising products to create one or more continuing streams of revenue from consumers, and wherein at least one of said first-tier advertisers or said second-tier advertisers receives a benefit from said streams of revenue.
